(19) United States
(12) Patent Application Publication
(10) Pub. No.: US 2011/0078681 A1
(43) Pub. Date: Mar. 31, 2011

(54) METHOD AND SYSTEM FOR RUNNING VIRTUAL MACHINE IMAGE

(75) Inventors: Ying Li, Beijing (CN); Jie Qiu, Beijing (CN); Jie Yang, Beijing (CN); Xiao Zhong, Beijing (CN)

(73) Assignee: INTERNATIONAL BUSINESS MACHINES CORPORATION, Armonk, NY (US)

(21) Appl. No.: 12/893,091

(22) Filed: Sep. 29, 2010

(30) Foreign Application Priority Data
Sep. 30, 2009 (CN) 200910174129.3

(51) Int. Cl. G06F 9/455

(52) U.S. Cl. 718/1

(57) ABSTRACT

A computer-implemented methods and systems for a running virtual machine image in a host machine. One method includes: receiving a virtual machine image provisioning request; sending to a storage server a request to copy a virtual machine image related to the virtual machine image provisioning request; receiving a portion of the virtual machine image; starting a virtual machine in the host machine by running the received portion of the virtual machine image; intercepting a file operation request of a program running in the virtual machine; and acquiring a file related to the file operation request.

### CROSS-REFERENCE TO RELATED APPLICATIONS

This application claims priority under 35 U.S.C. §119 to Chinese Patent Application No. 200910174129.3 filed Sep. 30, 2009, the entire contents of which are incorporated by reference herein.

### BACKGROUND OF THE INVENTION

1. Field of the Invention

The present invention relates to cloud computing. In particular, the present invention relates to method and system for running a virtual machine image in cloud computing.

2. Description of the Related Art

Cloud computing enables thousands of end users to effectively utilize computing capabilities of IT that are connected together through network without worrying about the utilized computing technology, access manner and so on. In cloud computing, computing capabilities of IT are provided by way of service. Virtualization technology is a technology widely used in cloud computing. In an existing cloud computing architecture, a virtual machine is usually used to provide service for users. Running a virtual machine in a cloud computing environment requires running a virtual machine image file, and the virtual machine image file usually includes an operating system, installed application program and available disk space. Usually, a smaller virtual machine image file is 4-5 GB. A larger virtual machine image file may be several hundreds of GB, for example, image file of TPM is approximately 100 GB.

In the existing technology, in order to run a virtual machine, an image file (including an operating system, installed application program and available disk space) of the entire virtual machine generally needs to be copied from a storage server to a host machine, and the virtual machine is then started from the virtual machine image file. After the virtual machine is started, the application program is run on the virtual machine. If data in the virtual machine image file is changed the application program is running, the changed virtual machine image file needs to be saved back to the storage server after the virtual machine is stopped.

In general, a server cluster will run many hosts (i.e. servers in cloud), and each host may run many virtual machines. As mentioned above, in order to run a virtual machine, the image file of the entire virtual machine needs to be copied from a storage server to a host. Since a relatively small virtual machine image file is generally around 4-5 GB, the copying of virtual machine image file will consume a great amount of network bandwidth. Meanwhile, the entire changed virtual machine image file also needs to be saved back to the storage server after the virtual machine is stopped, and as such, the process of storing will also consume a great amount of network bandwidth.

### SUMMARY OF THE INVENTION

According to one aspect of the invention, a computer-implemented method is provided for running a virtual machine image in a host machine. The method includes: receiving a virtual machine image provisioning request; sending to a storage server a request to copy a virtual machine image related to the virtual machine image provisioning request; receiving a portion of the virtual machine image; starting a virtual machine in the host machine by running the received portion of the virtual machine image; intercepting a file operation request of a program running in the virtual machine; and acquiring a file related to the file operation request.

According to another aspect of the invention, another computer-implemented method is provided for running a virtual machine image in a host machine. The method includes: receiving a request sent by the host machine to copy a virtual machine image related to a virtual machine image provisioning request; sending a portion of the virtual machine image to the host machine; receiving a request sent by the host machine to copy a file related to a file operation request; and sending the file related to the file operation request to the host machine.

According to still another aspect of the invention, a computer-implemented system is provided for running a virtual machine image in a host machine. The system includes: an image loader and an application loader. The image loader (i) receives a virtual machine image provisioning request; (ii) sends to a storage server, a request to copy a virtual machine image related to the virtual machine image provisioning request; (iii) receives a portion of the virtual machine image; and (iv) starts a virtual machine in the host machine by running the received portion of the virtual machine image. The application loader (i) intercepts a file operation request of a program running in the virtual machine; and (ii) acquires a file related to the file operation request.

According to yet another aspect of the invention, another computer-implemented system is provided for running a virtual machine image in a host machine. The system includes: an image visitor for (i) receiving a request sent by the host machine to copy a virtual machine image related to a virtual machine image provisioning request; (ii) sending a portion of the virtual machine image to the host machine; (iii) receiving a request sent by the host machine to copy a file related to a file operation request; and sending the file related to the file operation request to the host machine.

### BRIEF DESCRIPTION OF THE DRAWINGS

FIG. 1 shows a system 100 for running a virtual machine image in a host machine according to an embodiment of the present invention;

FIG. 2 shows a flow diagram 200 of a method for running a virtual machine image in a host machine according to an embodiment of the present invention;

FIG. 3 shows a flow diagram 300 of a method for a running virtual machine image in a host machine according to another embodiment of the present invention.

### DETAILED DESCRIPTION OF THE PREFERRED EMBODIMENTS

Illustrative embodiments of the present invention are described below in conjunction with accompany drawings. For the purpose of clarity and concise, not all features of an actual implementation are described in this specification. However, it will be appreciated that in the development of any such actual embodiment, numerous implementation-specific decisions should be made to achieve developers' specific goals, such as in compliance with system-related and business-related constraints, which may vary from one implementation to another. Moreover, it will be appreciated that although such a development effort might be complex and time-consuming, it is a routine undertaking for those of ordinary skill in the art having the benefit of this disclosure.

Here, it shall be noted that, in order to avoid obscuring the embodiments of the present invention by unnecessary details, only means structures and/or process steps that are closely associated with the solution of the embodiments of the present invention are illustrated in the drawings, and other details that have little relationship therewith are omitted.

In the embodiments of the present invention, since initially only a relatively small portion of virtual machine image needs to be transmitted, occupation of network bandwidth is significantly reduced. While, copying a file is driven by an application, only the necessary file will be copied from the storage server, thereby greatly reducing the occupation of network bandwidth. For example, running an application can require approximately 100 MB of the file while Apache is running, according to conventional approach. However, in order to run Apache, the entire virtual machine image that is approximately 4-5 GB have to be copied to a host machine through a network, thereby resulting in a large amount of network bandwidth waste. Embodiments of the present invention allows for approximately 100 MB of the file to run Apache to be copied through the network, thereby greatly reducing the consumption of network bandwidth.

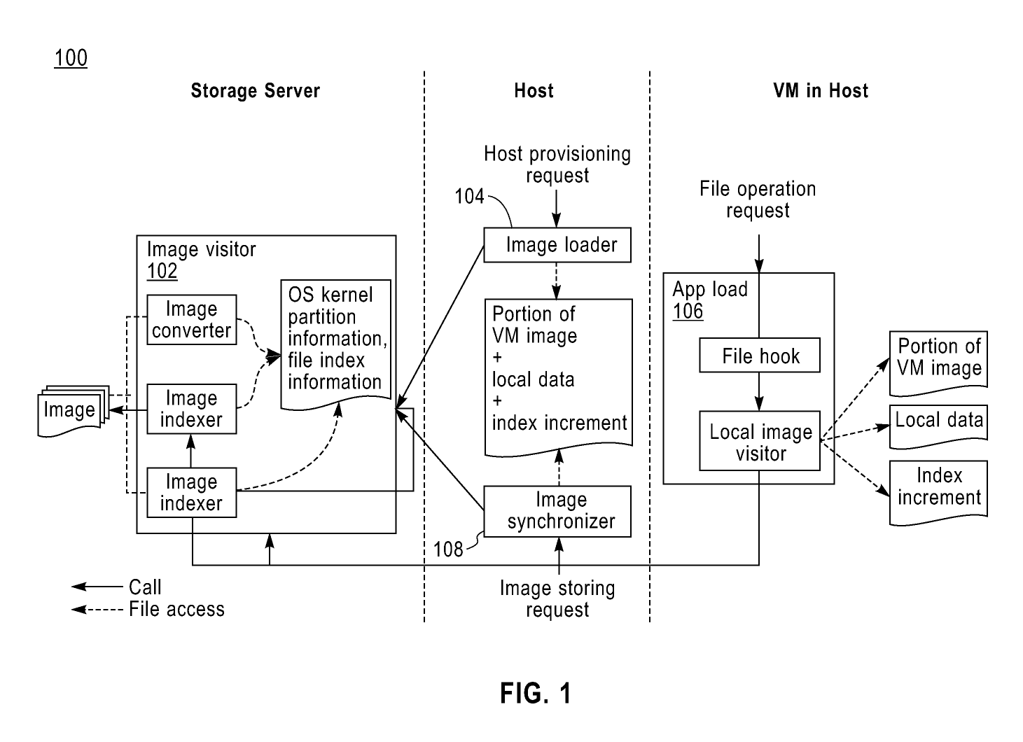

Referring to FIG. 1, a system 100 is shown for running a virtual machine image in a host machine according to an embodiment of the present invention. According to the embodiment, the system 100 for running a virtual machine image includes an image visitor 102, an image loader 104, an application loader 106 and an image synchronizer 108. Alternatively, the system 100 for running virtual machine image includes two subsystems, in which the image visitor 102 located in a storage server constitutes a server subsystem, and the image loader 104, application loader 106 and image synchronizer 108 located in the host and in the virtual machine running in the host constitute a host subsystem.

The image visitor 102 constituting the server subsystem is located in the storage server, and includes an image converter, an image indexer and an image file visitor. Herein, the image converter is used to convert an original virtual machine image into a portion of the virtual machine image. The portion of the virtual machine image includes at least an operating system kernel, partition information and file index information. The image indexer is used to generate file index information which is used to locate file in a virtual machine image. The image converter first acquires the operating system kernel and partition information by analyzing the virtual machine image, then generates a portion of virtual machine image in conjunction with file index information generated by the image indexer. The processes of acquiring the operating system kernel and partition information, creating file index information and generating a portion of the virtual machine image can be implemented by any means in the art, and will not be described for brevity. The above processes of the image converter and image indexer can be implemented offline, and can also be implemented dynamically. Preferably, the portion of the virtual machine image is prepared offline in advance. The image converter can also embed application loading code into the portion of the virtual machine image, so as to communicate with the application loader 106 located in a virtual machine running in the host.

The image file visitor is used to receive a file reading request issued from the application loader 106 located in a virtual machine running in a host, read a file in the virtual machine image and return it to the application loader 106 as a response. The image file visitor is also used to receive an updated file sent by the image synchronizer 108 located in a host and update the virtual machine image in a storage server.

The image loader 104, application loader 106 and image synchronizer 108 constituting the host subsystem will be described below. The image loader 104 located in a host is used to load (i.e. copy from storage server) the portion of the virtual machine image generated by the image converter. After the portion of the virtual machine image is loaded, the image loader 104 instantiates the portion of the virtual machine image based on partition information and file index information in the portion of the virtual machine image, and the process of instantiating is similar to that performed by a hypervisor, which will not be described for brevity.

The application loader 106 located in a virtual machine running in a host includes a file hook and a local image visitor. Herein, the file hook is used to intercept a file operation request of a program running in a virtual machine running in a host, and send it to the local image visitor. The local image visitor receives a file operation request intercepted by the file hook, checks partition information and file index information in the instantiated portion of the virtual machine image, and determines whether the file related to the file operation request is located in the local data in the virtual machine running in the host. If the file related to the file operation request is located in the local data, then a corresponding file is read through a file operation application program interface API. If the file related to the file operation request is not located in the local data in the virtual machine running in the host, a file reading request is sent to the image file visitor located in the image visitor 102 in the storage server, a response returned by the image file visitor that contains the file to related the file operation is received, and the file related to the file operation returned in the response is stored in the local data through the file operation application program interface API. The local image visitor is also used to record a change of file index information made by file operation incrementally (i.e. index increment).

The image synchronizer 108 located in a host is used to read the change of file index information recorded by the local image visitor, read updated file in the local data by using the changed file index information, and send the updated file to the image file visitor located in the image visitor 102 of the storage server to update the virtual machine image in the storage server.

The processes of the file hook and local image visitor located in the application loader 106 in the virtual machine running in a host will be described in detail below. The file hook can be implemented by any means in the art, and will not be described for brevity.

When the application loader 106 receives a file operation request of a program running in a host, the file hook in the application loader 106 intercepts the file operation request. For a different file operation request, the file hook cooperates with the local image visitor to perform a corresponding process respectively.

If the file operation request is a file opening request, i.e., the file request only needs to acquire file information, the file hook intercepts the file opening request and sends it to the local image visitor. The local image visitor reads partition information and file index information, and the file index information generally is a file allocation table. The local image visitor reads file descriptor in the file index information, acquires information such as corresponding file name, file storing path, file access right and so on, and the file open operation ends.

If the file operation request is a file reading request, the file hook intercepts the file reading request and sends it to the local image visitor. The local image visitor searches the local index for corresponding file information of the file related to the file reading request. If the file related to the file reading request is read for the first time, that is, if corresponding file information does not exist in the local index, the local image visitor sends a file reading request to the image file visitor located in the image visitor 102 of the storage server through a file hook. After a response containing the file related to the file reading request that is returned by the image file visitor is received, corresponding file information of the file related to the file reading request is recorded in the local index, and the file related to the file reading request that is returned in the response is stored in local data through the file operation application program interface API.

If after the local image visitor searches the local index for corresponding file information of the file related to the file reading request, and it is determined that the file related to the file reading request is not read for the first time, that is, corresponding file information already exists in the local index, then the local image visitor directly reads the related file from local data through the file operation application program interface API according to corresponding file information stored in the local index.

If the file operation request is a file creating request, the file hook intercepts the file creating request and sends it to the local image visitor. The local image visitor first reads partition information and file index information to avoid a file name to be created by the file creating request to be repeated with that present in the existing file index information. The file index information generally is a file allocation table. If there is no repeating file name, the local image visitor records the corresponding file information of the created new file in local index through a file hook, and creates a new file having a name to be created in local data through the file operation application program interface API.

If the file operation request is a file writing request, the file hook intercepts the file writing request and sends it to the local image visitor. The local image visitor writes a change of file related to the file writing request into local data through the file operation application program interface API. If the corresponding file information of the file related to the file writing request is changed, the local image visitor also records the change of the corresponding file information of the file related to the file writing request in local index.

After the file operation is performed, the local image visitor records the change of file index information incrementally, the image synchronizer 108 located in the host reads the change of file index information recorded by the local image visitor, reads updated file in the local data by using changed file index information and sends updated file to the image file visitor located in the image visitor 102 of storage server to update virtual machine image in the storage server.

According to another embodiment of the invention, a system is provided for running a virtual machine image in a host machine that includes an image loader 104 and an application loader 106. The image loader 104 (i) receives a virtual machine image provisioning request; (ii) sends to a storage server a request to copy a virtual machine image related to the virtual machine image provisioning request; (iii) receives a portion of the virtual machine image, where the portion of the virtual machine image includes at least an operating system kernel, partition information and file index information; and (iv) starts a virtual machine in the host by running the received portion of the virtual machine image. The application loader 106 (i) intercepts a file operation request of a program running in the virtual machine; and (ii) sends to the storage server a request to copy the file related to the file operation request; and (iii) receives the file related to the file operation request. Optionally, the system for running a virtual machine image can further include an image synchronizer 108 for sending data to update the virtual machine image in the storage server, if data in the virtual machine image running in the host has been changed.

According to another embodiment of the present invention, a system is provided for running a virtual machine image in a host machine that includes an image visitor 102 for: (i) receiving a request sent by the host machine to copy a virtual machine image related to a virtual machine image provisioning request; (ii) sending a portion of the virtual machine image to the host, where the portion of the virtual machine image includes at least an operating system kernel, partition information and file index information; (iii) receiving a request sent by the host to copy a file related to a file operation request; and (iv) sending the file related to the file operation request to the host. The image visitor can further (i) receive changed data in the virtual machine image running in the host and (ii) update the virtual machine image with the changed data. Optionally, the system for running a virtual machine image can further include: an image indexer for generating file index information; and an image converter for generating a portion of the virtual machine image by using the file index information generated by the image indexer.

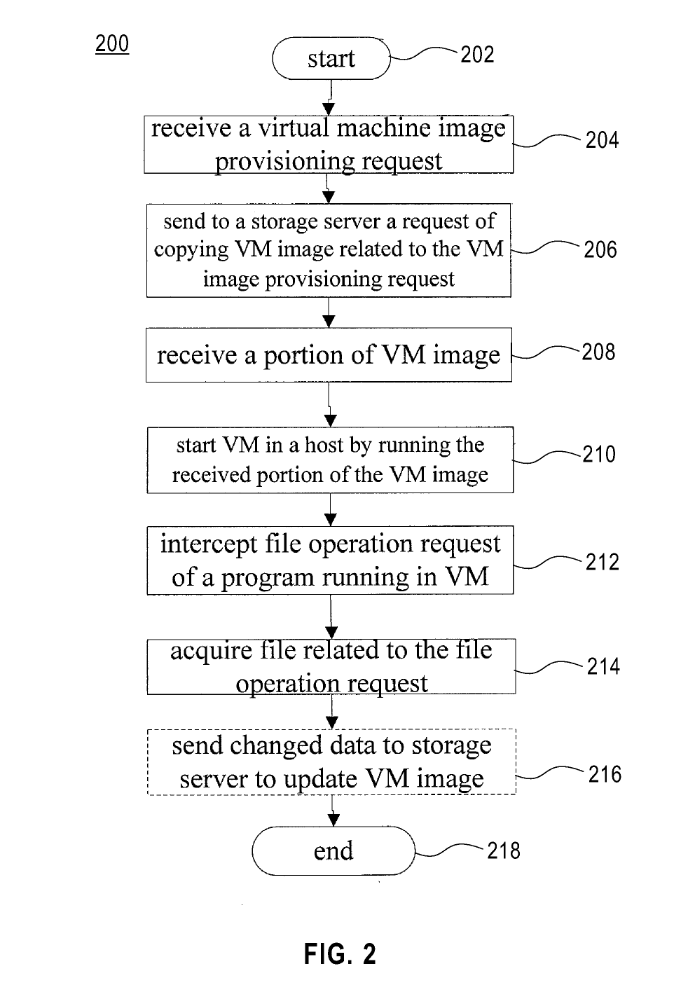

Now referring to FIG. 2, a flow diagram shows a method for running a virtual machine image in a host machine according to another embodiment of the present invention. According to the embodiment, the method 200 for running a virtual machine image in a host machine starts at step 202. Next, in step 204, a virtual machine image provisioning request is received by a host; then, in step 206, a request to copy a virtual machine image related to the virtual machine image provisioning request is sent to a storage server by the host; next, in step 208, a portion of the virtual machine image is received by the host, where the portion of the virtual machine image includes at least an operating system kernel, partition information and file index information; next, in step 210, a virtual machine is started in the host by running the received portion of the virtual machine image; next, in step 212, file operation request of a program running in the virtual machine is intercepted by the host; next, in step 214, a file related to the file operation request is acquired by the host. Further, the method 200 for running a virtual machine image further includes in step 216, sending data to the storage server to update the virtual machine image, if the data in the virtual machine image running in the host is changed during the running of the virtual machine. Then, the method 200 according to the embodiment of the present invention ends at step 218.

Further, when a file operation request is received, the method 200 according to the embodiment of the present invention performs corresponding processes with respect to a different file operation request, respectively.

If the file operation request is a file opening request, i.e., the file request only needs to acquire file information, then the partition information and file index information is read, information such as the corresponding file name, file storing path, file access right and so on is acquired, and the file open operation ends.

If the file operation request is a file reading request, then the local index is searched for the corresponding file information of the file related to the file reading request; if the file related to the file reading request is read for the first time, that is, the corresponding file information does not exist in the local index, the file reading request is sent to the storage server. After a returned response containing the file related to the file reading request is received, the corresponding file information of the file related to the file reading request is recorded in the local index, and the file related to the file reading request that is returned in the response is stored in the local data through a file operation application program interface API. If, after the local index is searched for the corresponding file information of the file related to the file reading request, it is determined that the file related to the file reading request is not read for the first time, that is, the corresponding file information already exists in the local index, then the related file is read directly from the local data the through file operation application program interface API according to the corresponding file information stored in the local index.

If the file operation request is a file creating request, first the partition information and the file index information is read to prevent the file creating request from creating a repeated file name with that present in the existing file index information. If there is no repeating file name, the corresponding file information of the created new file is recorded in the local index, and a new file having a name to be created is created in the local data through the file operation application program interface API.

If the file operation request is a file writing request, a change of the file related to the file writing request is written into the local data through the file operation application program interface API. If the corresponding file information of the file related to the file writing request is changed, the change of the corresponding file information of the file related to the file writing request is also recorded in the local index.

After the file operation is performed, the change of file index information is recorded incrementally. The updated file in the local data is read by using the changed file index information and the updated file is sent to the storage server to update the virtual machine image in the storage server.

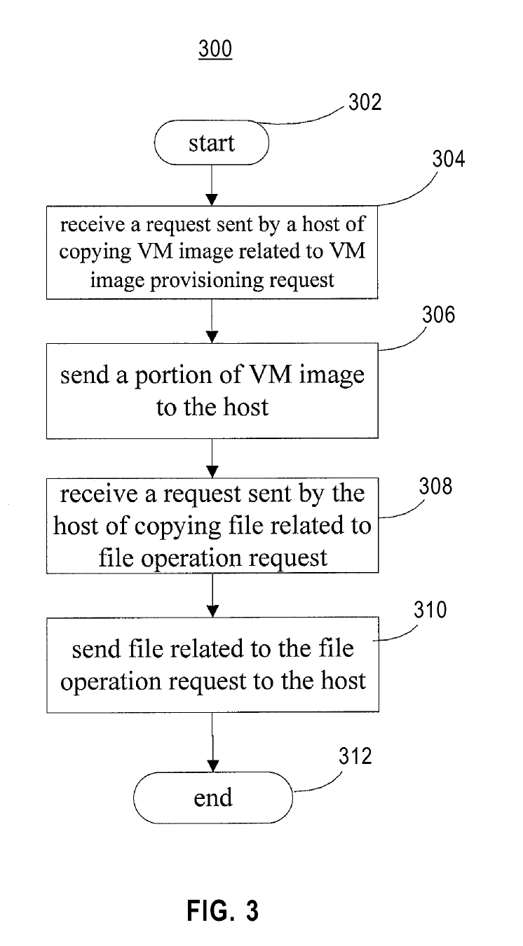

Now referring to FIG. 3, a flow diagram shows a method 300 for running a virtual machine image in a host machine according to another embodiment of the present invention. According to the embodiment, the method 300 for running a virtual machine image in a host machine starts at step 302. Next, in step 304, a request to copy a virtual machine image related to a virtual machine image provisioning request sent by the host is received; then, in step 306, a portion of the virtual machine image is sent to the host, where the portion of the virtual machine image includes at least an operating system kernel, partition information and file index information; next, in step 308, a request to copy a file related to a file operation request sent by the host is received; next, in step 310, the file related to the file operation request is sent to the host. Then, the method 300 according to the embodiment of the present invention ends in step 312. Further, the method 300 for running a virtual machine image can further include generating file index information; and generating a portion of the virtual machine image by using the generated file index information.

The basic principles of the present invention are described above in conjunction with specific embodiments, however, it is to be noted that, for those of ordinary skill in the art, it will be understood that all or any step or component of the method and apparatus of the invention can be implemented in any computing apparatus (including processor, storage medium etc) or network of a computer apparatus in the form of hardware, firmware, software or a combination thereof, which is achievable for those of ordinary skill in the art by using their basic programming skills after reading the description of the present invention.

Thus, the embodiments of the present invention can also be implemented by a computer program or a group of computer programs executed on a computing apparatus. The computing apparatus can be a known general purpose apparatus. Thus, the embodiments of the present invention can also be implemented by merely providing a program product containing computer program codes for implementing the method or apparatus. That is, such a program product can also constitute the present invention, and the storage medium on which such program product is stored can also constitute the present invention. The storage medium can be a known storage medium or a storage medium that will be developed in the future.

It should also be noted that, in the apparatus and method of the present invention, each component or each step can be separated and/or recombined. Such separation and/or recombination should be considered as an equivalent solution of the present invention. Further, the steps for performing the above series of processes can be naturally executed in a time sequence according to a sequence of the description, but does not necessarily need to be executed in time sequence. Some steps can be executed in parallel or independently from each other.

Although the present invention and its advantages have been described in detail, it should be appreciated that various modifications, replacements and alternations can be made without departing from the spirit and scope of the present invention defined by the appended claims. Further, the term “comprising”, “including” or any other variations is intended to cover non-exclusive inclusion. Thereby the procedure, method, item or apparatus that contains a series of elements can also contain other elements that are not listed explicitly, or contain elements inherent in such procedure, method, item or apparatus. Unless otherwise defined, an element defined by the phase “including a . . . ” does not exclude other similar elements that also exist in the procedure, method, item or apparatus that contains that element.

What is claimed is:

1. A computer-implemented method for running a virtual machine image in a host machine, said method comprising:
receiving a virtual machine image provisioning request;
sending to a storage server a request to copy a virtual machine image related to said virtual machine image provisioning request;
receiving a portion of said virtual machine image, wherein said portion of said virtual machine image comprises: an operating system kernel, partition information, and file index information;
starting a virtual machine in said host machine by running said received portion of said virtual machine image;
intercepting a file operation request of a program running in said virtual machine; and
acquiring a file related to said file operation request.

2. The method according to claim 1, further comprising:
sending data to update said virtual machine image in said storage server, wherein said step of sending data to update said virtual machine image in said storage server is performed if said data in said virtual machine image running in said host machine has been changed.

3. The method according to claim 1, further comprising:
recording a change of said file index information incrementally.

4. The method according to claim 1, further comprising:
reading said file related to said file operation request directly from local data, wherein said step of reading said file related to said file operation request directly from local data is performed if said file related to said file operation request already exists in said local data of said virtual machine running in said host machine.

5. The method according to claim 1, further comprising:
sending to said storage server a request to copy said file related to said file operation request and receiving said file related to said file operation request from said storage server, wherein said step of sending to said storage server a request to copy said file related to said file operation request and receiving said file related to said file operation request from said storage server is performed if said file related to said file operation request does not exist in local data of said virtual machine running in said host.

6. A computer-implemented method for running a virtual machine image in a host machine, said method comprising:
receiving a request sent by said host machine to copy a virtual machine image related to a virtual machine image provisioning request;
sending a portion of said virtual machine image to said host machine, wherein said portion of said virtual machine image comprises: an operating system kernel, partition information and file index information;
receiving a request sent by said host machine to copy a file related to a file operation request; and
sending said file related to said file operation request to said host machine.

7. The method according to claim 6, further comprising:
receiving changed data in said virtual machine image running in said host machine; and
updating said virtual machine image with said changed data.

8. The method according to claim 6, further comprising:
generating said file index information; and
generating a portion of said virtual machine image by using said generated file index information.

9. A computer-implemented system for running a virtual machine image in a host machine, said system comprising:
an image loader for
(i) receiving a virtual machine image provisioning request;
(ii) sending to a storage server, a request to copy a virtual machine image related to said virtual machine image provisioning request;
(iii) receiving a portion of said virtual machine image, wherein said portion of said virtual machine image comprises: an operating system kernel, partition information and file index information; and
(iv) starting a virtual machine in said host machine by running said received portion of said virtual machine image; and
an application loader for
(i) intercepting a file operation request of a program running in said virtual machine; and
(ii) acquiring a file related to said file operation request.

10. The system according to claim 9, further comprising:
an image synchronizer for sending data to update said virtual machine image in said storage server, wherein said image synchronizer sends data to update said virtual machine image in said storage server if said data in said virtual machine image running in said host machine has been changed.

11. The system according to claim 9, wherein:
said application loader further records a change of said file index information incrementally; and
said image synchronizer further reads a change of said file index information.

12. The system according to claim 9, wherein:
said application loader further reads said file related to said file operation request directly from local data, wherein said application loader reads said file related to said file operation request directly from local data if said file related to said file operation request already exists in said local data of said virtual machine running in said host machine.

13. The system according to claim 9, wherein:
said application loader further sends to said storage server a request to copy said file related to said file operation request and further receives said file related to said file operation request from said storage server, wherein said application loader sends to said storage server a request to copy said file related to said file operation request and receives said file related to said file operation request from said storage server if said file related to said file operation request does not exist in local data of said virtual machine running in said host machine.

14. A computer-implemented system for running a virtual machine image in a host machine, comprising
an image visitor for:
(i) receiving a request sent by said host machine to copy a virtual machine image related to a virtual machine image provisioning request;
(ii) sending a portion of said virtual machine image to said host machine, wherein said portion of said virtual machine image comprises: an operating system kernel, partition information and file index information;
(iii) receiving a request sent by said host machine to copy a file related to a file operation request; and
(iv) sending said file related to said file operation request to said host machine.

15. The system according to claim 14, wherein said image visitor further:
receives changed data in said virtual machine image running in said host machine; and
updates said virtual machine image with said changed data.

16. The system according to claim 14, further comprising:
an image indexer for generating said file index information; and
an image converter for generating a portion of said virtual machine image by using said file index information generated by said image indexer.

17. An article of manufacture tangibly embodying computer readable instructions which when implemented, cause a computer to carry out the steps of a computer-implemented method for running a virtual machine image in a host machine according to claim 1.

18. An article of manufacture tangibly embodying computer readable instructions which when implemented, cause a computer to carry out the steps of a computer-implemented method for running a virtual machine image in a host machine according to claim 6.
